(19) United States
(12) Patent Application Publication
(10) Pub. No.: US 2020/0251963 A1
(43) Pub. Date: Aug. 6, 2020

(54) ELECTRIC MOTOR WITH LIQUID COOLED ROTOR

(71) Applicants: George R. Woody, Anaheim, CA (US); Paul F. Carosa, Covina, CA (US); Harry X. Chang, Upland, CA (US)

(72) Inventors: George R. Woody, Anaheim, CA (US); Paul F. Carosa, Covina, CA (US); Harry X. Chang, Upland, CA (US)

(21) Appl. No.: 15/675,775

(22) Filed: Aug. 13, 2017

(51) Int. Cl. H02K 9/19; H02K 9/22; H02K 5/20; H02K 5/18

(52) U.S. Cl. CPC H02K 9/19; H02K 5/18; H02K 5/20; H02K 9/22

(57) ABSTRACT

An electric drive motor with an improved liquid cooling system featuring a hollow rotor shaft configured to allow liquid coolant to flow in and out of the rotor shaft through an aperture in one distal end following a path influenced by a coolant tube such that the liquid coolant is directed to flow past a plurality of internally located heat dissipation fins which are in thermal communication with the rotor shaft thereby increasing the heat dissipation, performance, and power density.

### FIELD OF THE PRESENT DISCLOSURE

This disclosure relates generally to electric motor technology and more specifically to an electric traction drive motor with an innovative liquid cooled rotor capable of enhanced thermal dissipation resulting in improved performance and power density.

### BACKGROUND OF THE RELATED ART

As electric motor technology advances, electric motors are being used in an increasing number of applications, many of which require high performance and high efficiency. In such high demanding applications, the ability to quickly dissipate heat is extremely important because as performance demands on an electric motors increase, heat generation typically increases as well. The increased heat can be a performance limiting factor if it is not adequately dissipated; therefore, innovative and more efficient heat dissipation techniques are at the forefront of electrical motor advances. This is especially true with induction motors which tend to generate more heat in the rotor than permanent magnet motors.

Excessive heat buildup caused by insufficient heat dissipation can result in many undesirable effects, such as premature deterioration of materials, increased thermal expansion challenges, decreased electromagnetic efficiency, and/or unreasonable fire or other temperature related risks. In many situations, such concerns cause an electric motor's performance to be intentionally governed or restricted so as to prevent heat generation from outpacing the capabilities of the legacy heat dissipation technologies. In such cases, even incremental improvements in heat dissipation technology can yield immediate performance gains.

Most advanced heat dissipation designs for electric motors involve liquid coolants because liquid coolants can be directed to flow to a heat source, absorb heat energy from the heat source, and then be directed to flow away from the heat source while physically carrying the absorbed heat energy to be dissipated elsewhere in a more convenient location. Such systems can usually remove more heat energy more quickly than solid state heat dissipation designs which rely primarily on the thermal conductivity of the materials to transport the heat energy away from the generation source.

Examples of liquid coolant heat dissipation systems in electric motors can be found in U.S. Pat. Nos. 7,489,057 and 8,970,075. In U.S. Pat. No. 7,489,057, a coolant feed tube is rigidly attached at intervals to the internal surface of a hollow rotor shaft in a coaxial orientation with its terminal end oriented just short of the end of the internal hollowed cavity of the rotor shaft such that coolant can flow in a first direction through the coolant feed tube and return in a second, opposing direction by flowing outside of the coolant feeding tube through the space between the external surface of the coolant feed tube and the internal surface of the hollowed rotor shaft. This design allows the rotor shaft to dissipate heat by transferring heat from the rotor shaft to the coolant fluid and as it flows past, the primary heat transfer surface being the internal surface of the hollowed rotor shaft that contacts the coolant fluid when it is flowing along its return path.

Similarly, in U.S. Pat. No. 8,970,075, coolant is directed into a hollowed portion of the rotor shaft; however, in this design, the coolant fluid flows radially outwards and then through axial holes strategically located adjacent to the rotor slots where heat is transferred from the rotor to the coolant fluid and is removed for dissipation elsewhere. This method presents challenges in managing fluid path leakage.

As in all heat dissipation systems, the performance of a particular system design is measured by how quickly heat energy can be removed from the critical location. This performance is a function of several variables including the thermal qualities of the coolant fluid such as fluid temperature, specific heat, and thermal conductivity, and physical properties of the heat transfer interface such as and the size of the surface area that experiences contact with the coolant fluid, the turbulence of the fluid, and the time the coolant fluid spends in contact with the heat transfer surfaces (i.e. fluid velocity and flow rate). In order to improve heat transfer performance one or more of these several variables must be improved or enhanced. As previously stated, in many cases, improvements in heat dissipation can yield immediate performance increases in electric motor performance; therefore, there exists a strong need for even incremental improvements in heat dissipation technology.

The present disclosure distinguishes over the related art providing heretofore unknown advantages as described in the following summary.

### BRIEF SUMMARY OF THE INVENTION

The present disclosure describes an innovative highly efficient liquid cooled electric motor apparatus. Similar to the previously disclosed liquid cooled rotor assemblies, the present disclosure includes a hollow rotor shaft through which a liquid coolant can flow. However, unlike previous configurations, the present disclosure increases the exposure of the liquid coolant to heat dissipation surfaces through the addition of a plurality of heat dissipation fins which facilitate increased heat removal and consequently increases performance, including improved power density and efficiency.

Specifically, the present disclosure teaches a hollow rotor shaft with one open distal end and one closed distal end, and a cooling tube that coaxially extends into the hollow rotor shaft through the open distal end of the rotor shaft and terminates inside the rotor shaft's hollow center.

Similar to previous liquid cooled motor designs, this configuration directs liquid coolant to flow in a first direction through the coolant tube, and upon exiting the coolant tube, the coolant fluid is allowed to flow in a second, opposite direction through the space between the outer surface of the coolant tube and the inner surface of the hollow rotor shaft. In legacy designs, it is during this return path that the coolant fluid absorbs the most heat energy because the coolant fluid is in direct contact with the inner surface of the hollow rotor shaft.

The present disclosure improves upon legacy designs in that it further includes a plurality of heat dissipation fms placed in the cooling fluid's return path. This innovative feature significantly increases the heat transfer surface area that comes in contact with the cooling fluid and thereby significantly increases the heat dissipation rate.

In an alternative embodiment, the coolant flow can be reversed such that it directly enters the space defined by the outer surface of the coolant tube and the inner surface of the hollow rotor shaft, then flows past the heat dissipation fins, and reverses direction and exits through the coolant tube. Regardless of the direction of the coolant flow, the presently disclosed innovative design increases motor performance by more efficiently removing the performance limiting heat energy.

The magnitude of the performance increase realized by utilizing this innovative feature depends on both the shape of the heat transfer fms and the material from which the fms are constructed. Preliminary Computational Fluid Dynamics (CFD) simulations performed using copper round folded fins yielded a twenty-six percent (26%) reduction of rotor temperature compared to the legacy designs without heat dissipation fins when operating continuously under 75 watts. When aluminum round fins were utilized in similar conditions, a temperature reduction of twenty-three percent (23%) was realized.

There is a wide variety of heat dissipation fin designs that may be utilized. Some design examples include: round crest fms; folded fms; louvered fins; lanced offset fins; and wavy fins. This list is not intended to be exhaustive. The material from which the fins are constructed may be varied so long as the chosen material exhibits good thermal conductivity properties, such as copper, aluminum, or steel. Composites and/or synthetic materials that are capable of exhibiting similar thermal properties may be utilized as well.

In a preferred embodiment, such fins are affixed to the inner surface of the rotor shaft. The manner in which they are affixed can have a significant effect on the performance of the innovation because it directly influences how well the heat energy can flow from the rotor shaft to the fms. In some embodiments, the heat dissipation fins are vacuum brazed or soldered to the inner surface of the hollow rotor shaft. In other embodiments, the fms may be integrated into a solid tubular extrusion that is either press fit into a hollow shaft, or serves as this shaft itself with rotor shaft termini welded or otherwise affixed to its extremities.

In the present disclosure the cooling tube is stationary and is supported at one distal end by a press fit junction with a stationary flange attached to the stator assembly so the heat dissipation fms that are affixed to the inner surface of the rotor shaft cannot also be attached the external surface of the coolant tube. This stationary coolant tube design eliminates the need for a dynamic junction for the coolant tube that would otherwise be required as the coolant tube passed from the stationary stator assembly to the rotating rotor assembly.

However, in some legacy designs, such a dynamic junction is included and the coolant tube is directly attached to the rotor shaft and rotates at the same rate. In such designs it is possible to incorporate heat dissipation fms that are directly affixed to both the inner surface of the rotor shaft and the outer surface of the coolant tube. The most important factor when implementing the presently disclosed innovation is that heat dissipation fins are in good thermal communication with the heat source, which typically requires the fms to be physically connected to the inner surface of the rotor shaft.

This disclosure teaches certain benefits in construction and use which give rise to the objectives described below.

A primary objective inherent in the above described method and apparatus is to provide advantages not taught by the prior art.

Another objective is to provide an electric traction drive motor with increased heat dissipation capabilities.

A further objective is to provide an electric traction drive motor capable of performing while exhibiting relatively lower rotor and stator winding operating temperatures.

A still further objective is to provide an electric drive motor with increased power density and efficiency.

Other features and advantages of the present invention will become apparent from the following more detailed description, taken in conjunction with the accompanying drawings, which illustrate, by way of example, the principles and features of the presently described apparatus.

### BRIEF DESCRIPTION OF THE SEVERAL VIEWS OF THE DRAWING(S)

The accompanying drawings illustrate various exemplary implementations and are part of the specification. The illustrated implementations are proffered for purposes of example not for purposes of limitation. Illustrated elements will be designated by numbers. Once designated, an element will be identified by the identical number throughout. Illustrated in the accompanying drawing(s) is at least one of the best mode embodiments of the present disclosure. In such drawing(s):

FIG. 1 is a perspective cutaway view of an exemplary embodiment of the presently disclosed thermally efficient, liquid cooled electric traction drive motor featuring a plurality of heat dissipation fins affixed to the inner surface of the hollow rotor shaft.

FIG. 2 is a side plan cutaway view of an exemplary embodiment of the presently disclosed thermally efficient liquid cooled electric traction drive motor featuring a plurality of heat dissipation fms affixed to the inner surface of the hollow rotor shaft with arrows indicating the directional flow of the cooling fluid.

FIG. 3 is a perspective cutaway view of an exemplary embodiment of the presently disclosed thermally efficient, liquid cooled electric traction drive motor featuring a rotor shaft that is comprised of a tubular extrusion featuring internal heat dissipation fins with rotor shaft termini affixed at both extremities.

FIG. 4 is a plan cutaway view of an exemplary embodiment of the presently disclosed thermally efficient, liquid cooled electric traction drive motor featuring a rotor shaft that is comprised of a tubular extrusion featuring internal heat dissipation fms with rotor shaft termini affixed at both extremities, also including arrows indicating the directional flow of the cooling fluid.

FIG. 5 is an axial plan cutaway view of an exemplary embodiment of the presently disclosed thermally efficient liquid cooled electric traction drive motor featuring a plurality of heat dissipation fms affixed to the inner surface of the hollow rotor shaft and not the outer surface of the stationary coolant tube.

FIG. 6 is a perspective view and an axial plan view of a plurality of exemplary round folded style heat dissipation fins.

FIG. 7 is a perspective view and an axial plan view of a plurality of exemplary lanced offset style heat dissipation fins.

FIG. 8 is a perspective view and an axial plan view of an exemplary tubular extrusion featuring internal heat dissipation fms.

### DETAILED DESCRIPTION OF THE EXEMPLARY EMBODIMENT

The above described drawing figures illustrate an exemplary embodiment of presently disclosed apparatus and its many features in at least one of its preferred, best mode embodiments, which is further defined in detail in the following description. Those having ordinary skill in the art may be able to make alterations and modifications to what is described herein without departing from its spirit and scope of the disclosure. Therefore, it must be understood that what is illustrated is set forth only for the purposes of example and that it should not be taken as a limitation in the scope of the present apparatus or its many features.

Described now in detail is an efficient electric traction drive motor with an innovative liquid cooled rotor capable of enhanced thermal dissipation resulting in greater performance and power density.

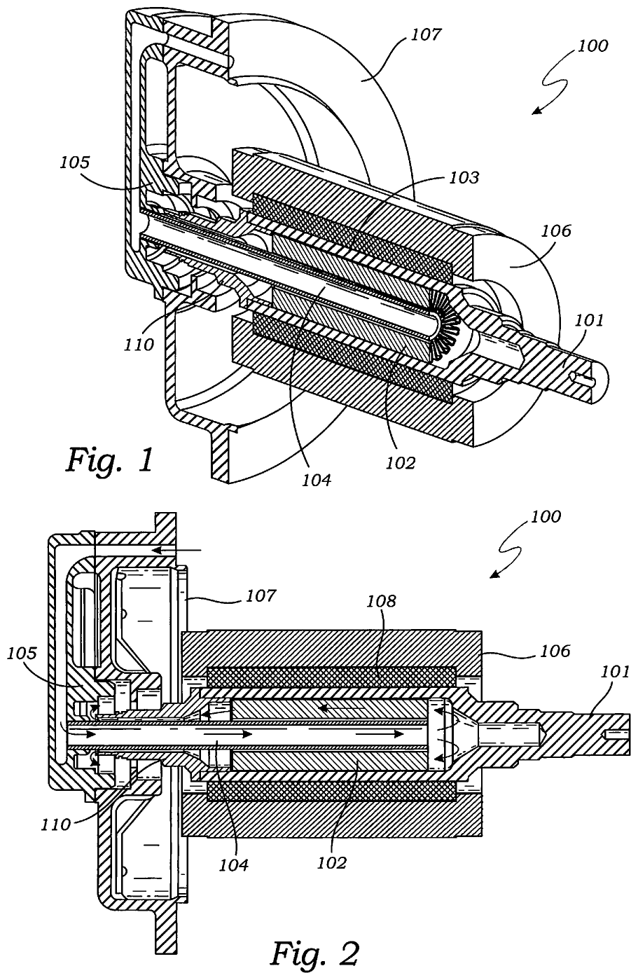

FIG. 1 illustrates an exemplary cut away perspective of the presently disclosed apparatus 100 featuring a stationary coolant tube 104 held in position by a press fit junction with a coolant tube support 105 affixed to the stator housing assembly 107. In normal operation, heat is generated in the rotor conductors 106 and iron structure 108. The heat is subsequently dissipated in all directions, including into the rotor shaft 110, 101, which in a typical design may heat up until it negatively affects performance. However, in the presently disclosed innovative design, this is where heat energy is removed through innovative heat exchange features located within the rotor shaft 110, 101.

The rotor shaft 110, 101 illustrated in FIG. 1 is constructed from two separate affixed portions; a front portion 101 comprising a hollow elongated shaft which is open on one end and closed on the other, and a rear portion 110 designed to mate with the open end of the front portion 101 and also featuring a concentric hole in its terminal end sized to exceed the diameter of the coolant tube 104, thereby allowing the coolant tube 104 to extend unobstructed from the coolant tube support 105, through the concentric hole in the rear portion 110 of the rotor shaft 110, 101 and terminate in the hollow center of the front portion 101 of the rotor shaft 110, 101.

Affixed to the inner surface of the hollow center of the front portion 101 of the rotor shaft 110, 101 is a plurality of heat dissipation fms 102. The heat dissipation fms 102 increase the rate at which heat energy can be dissipated by increasing the contact surface area with the liquid coolant. It is important that the heat dissipation fins 102 are affixed to the inner surface of the front portion 101 of the rotor shaft 110, 101 in a thermally conductive manner so that heat energy can flow from the rotor conductors 106 and iron structure 108, through the front portion 101 of the rotor shaft 110, 101 into the heat dissipation fms 102, and eventually into the passing liquid coolant to be carried away for dissipation elsewhere. It is also important that the interface between the rotor iron 108 and the front portion 101 of the rotor shaft 110, 101 has minimal thermal resistance. This may be enhanced by smooth surface finishes and use of thermally conductive paste.

FIG. 2 illustrates the flow path of the coolant through the presently disclosed innovative apparatus 100. As indicated by the arrows, the coolant fluid first enters stator housing assembly 107, then passes through the coolant tube support 105 and into the coolant tube 104. Upon exiting the terminal end of the coolant tube 104, the coolant fluid is forced to change direction and flow back along the outside of the coolant tube 104 through a plurality of heat dissipation fms 102 in the space defined by the outer surface of the coolant tube 104 and the inner surface of the front portion 101 of the rotor shaft 110, 101. Finally, the coolant fluid exits the system through the space defined by the outer surface of the coolant tube 104 and the inner surface of the concentric hole in the rear portion 110 of the rotor shaft 110, 101 and exits through an effluent channel in the stator 107. In an alternative embodiment, the coolant fluid can be designed to flow in the opposite direction as well, thereby passing the heat dissipation fms 102 before reversing direction and exiting out through the coolant tube 104.

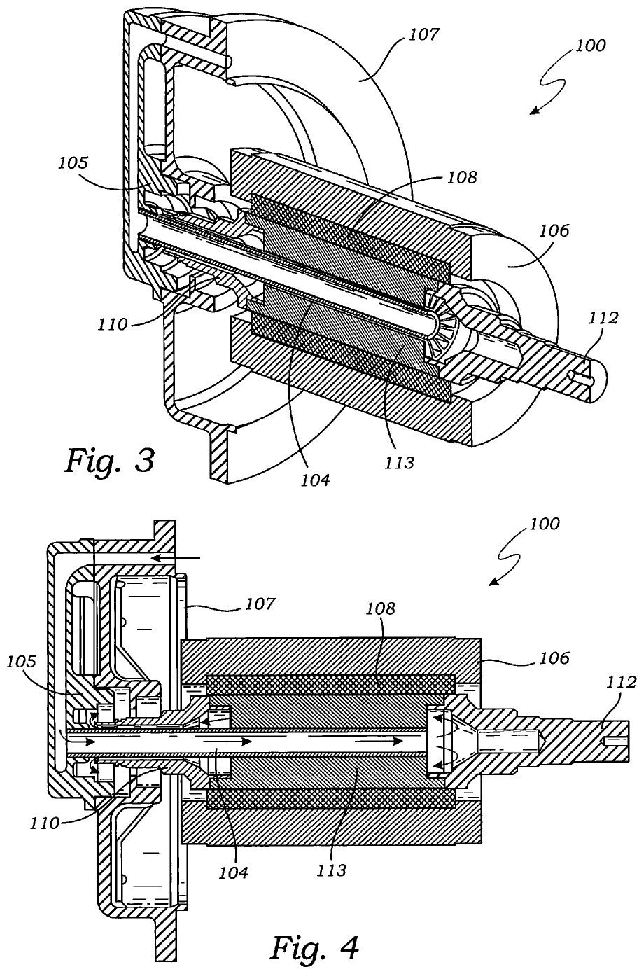

FIG. 3 illustrates a cutaway perspective of an alternative embodiment of the presently disclosed apparatus 100 wherein the heat dissipation fins 102 are an integral part of a tubular extrusion 113. In this embodiment, rather than affixing heat dissipation fms 102 to the inner surface of the hollow rotor shaft (previously 110, 101), the tubular extrusion 113 includes radially oriented internal heat dissipation fins as part of the solid tubular extrusion 113 (as depicted in FIG. 8) and acts as the center portion of a three-part rotor shaft 110, 113, 112 comprised of the extrusion 113 with a pair of rotor shaft termini 110, 112 welded or otherwise affixed at each extremity.

FIG. 4 is a cutaway plan view of the same embodiment illustrated in FIG. 3 further illustrating the directional flow of the coolant fluid. As with previous embodiments, it is possible for the coolant fluid to flow in the opposite direction as well so long as the coolant fluid's path includes contact with the heat dissipation fins of the extrusion 113, the apparatus will perform with higher efficiency than legacy designs.

In yet a further embodiment, the tubular extrusion 113 may be press fit into the hollow portion of the front portion 101 of the rotor shaft 110, 101 depicted in FIGS. 1 and 2 rather than acting as an integral part of the rotor shaft 110, 113, 112 depicted in FIGS. 3 and 4.

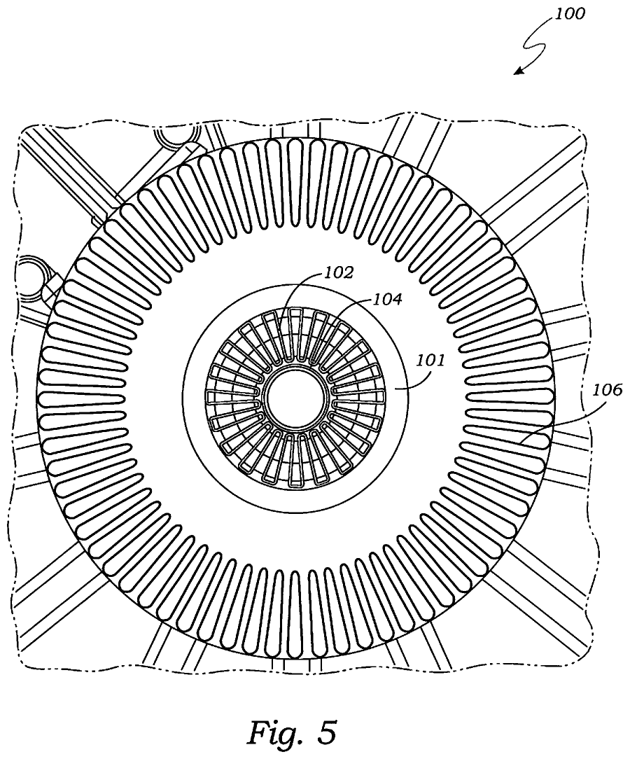

FIG. 5 illustrates a cross section of the presently disclosed apparatus 100. This perspective shows that the plurality of heat dissipation fms 102 are affixed to the inner surface of the front portion 101 of the rotor shaft 110, 101 and not the outer surface of the stationary coolant tube 104. In other embodiments where the coolant tube 104 rotates at the same rate as the rotor shaft 110, 101 it is possible for the plurality of heat dissipation fins 102 to be attached to both the inner surface of the front portion 101 of the rotor shaft 110, 101 and the outer surface of the coolant tube 104 as long as the coolant tube 104 is allowed to rotate freely of tube support 105 shown in FIGS. 1,2,3 and 4 with a circular seal arrangement.

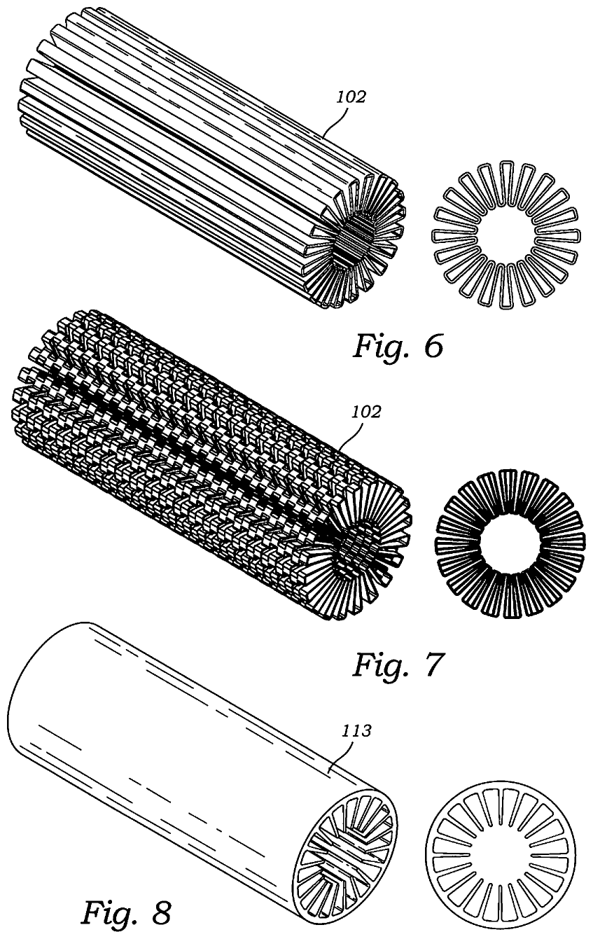

FIGS. 6 and 7 feature different styles of heat dissipation fms 102, namely a folded fm design and a lanced offset fm design, respectively. There are a great variety of heat dissipation fm 102 designs that can be utilized. Heat dissipation fin 102 shape can be optimized for performance in light of many design concerns including construction costs, heat exchange surface area, and drag resistance.

FIG. 8 illustrates an exemplary tubular extrusion 113 featuring internal radial heat dissipation fins. The tubular extrusion 113 eliminates the need for affixing heat dissipation fms 102 to the inner surface of the hollow front portion 101 of the rotor shaft 110, 101 because they are an integral part of the tubular extrusion 113. As previously mentioned, the tubular extrusion 113 can be press fit into the hollow front portion 101 of the rotor shaft 110, 101 or the tubular extrusion 113 can serve as the center piece in a three piece the rotor shaft 110, 113, 112 as illustrated in FIGS. 3 and 4.

The enablements described in detail above are considered novel over the prior art of record and are considered critical to the operation of at least one aspect of the apparatus and its method of use, and to the achievement of the above-described objectives. The words used in this specification to describe the instant embodiments are to be understood not only in the sense of their commonly defined meanings, but to include by special definition in this specification: structure, material, or acts beyond the scope of the commonly defined meanings. Thus, if an element can be understood in the context of this specification as including more than one meaning, then its use must be understood as being generic to all possible meanings supported by the specification and by the word(s) describing the element.

The definitions of the words or drawing elements described herein are meant to include not only the combination of elements which are literally set forth, but all equivalent structures, materials or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, substitutions, now or later known to one with ordinary skill in the art, are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A liquid cooled electric motor apparatus, said apparatus comprising:
a rotor shaft with a hollow center having a first and a second rotor shaft distal end, said first rotor shaft distal end having an axial aperture leading to the hollow center of said rotor shaft and said second rotor shaft distal end having a closed end;
a rotor assembly rigidly affixed to said rotor shaft;
a stator assembly being rotatably engaged with said rotor shaft;
a cooling tube, extending between a first and a second cooling tube distal end, supported in an internal and coaxially orientation in relation said rotor shaft such that said first cooling tube distal end is located outside of said rotor shaft proximate to said first rotor shaft distal end and said coolant tube extends through said axial aperture in said first rotor shaft distal end and terminates at said second cooling tube distal end located in the hollow center of said rotor shaft; and
a plurality of heat dissipation fins located between the external surface of said cooling tube and the internal surface of the hollow center of said rotor shaft.

2. An apparatus as in claim 1 wherein said cooling tube is supported by a coolant tube support firmly adjoined to said coolant tube's first distal end supporting said coolant tube in a cantilever fashion.

3. An apparatus as in claim 1 wherein said cooling tube is stationary and does not rotate with said rotor shaft.

4. An apparatus as in claim 1 wherein said cooling tube rotates with said rotor shaft and further comprises a dynamic seal allowing said coolant tube to rotate.

5. An apparatus as in claim 1 wherein said plurality of heat dissipation fins are in thermal communication with the inner surface of the hollow center of said rotor shaft.

6. An apparatus as in claim 5 wherein said plurality of heat dissipation fms are a plurality of round folded fins.

7. An apparatus as in claim 5 wherein said plurality of heat dissipation fins are a plurality of lanced offset fins.

8. An apparatus as in claim 5 wherein said plurality of heat dissipation fins are a tubular extrusion featuring a plurality of extruded fins.

9. A liquid cooled electric motor apparatus, said apparatus comprising:
a rotor shaft with a hollow center having a first and a second rotor shaft distal end, said first rotor shaft distal end having an axial aperture leading to the hollow center of said rotor shaft and said second rotor shaft distal end having a closed end;
a rotor assembly rigidly affixed to said rotor shaft;
a stator assembly being rotatably engaged with said rotor shaft;
a cooling tube, with a first and a second cooling tube distal end, supported in an internal and coaxially orientation in relation said rotor shaft such that said first cooling tube distal end is located outside of said rotor shaft proximate to said first rotor shaft distal end and said coolant tube extends through said axial aperture in said first rotor shaft distal end and terminates at said second cooling tube distal end located in the hollow center of said rotor shaft, so that cooling fluid may enter said cooling tube at said first cooling tube distal end and flow in a first direction until it exits said cooling tube at said second cooling tube distal end and then is directed to flow in a second, opposite direction through the space defined by the external surface of said cooling tube and the internal surface of said rotor shaft;
a plurality of heat dissipation fins located between the external surface of said cooling tube and the internal surface of said rotor shaft such that the coolant fluid must pass by said plurality of heat dissipation fins.

10. An apparatus as in claim 9 wherein said cooling tube is supported by a coolant tube support firmly adjoined to said coolant tube's first distal end supporting said coolant tube in a cantilever fashion.

11. An apparatus as in claim 9 wherein said cooling tube is stationary and does not rotate with said rotor shaft.

12. An apparatus as in claim 9 wherein said cooling tube rotates with said rotor shaft.

13. An apparatus as in claim 9 wherein said plurality of heat dissipation fins are in thermal communication with the inner surface of the hollow center of said rotor shaft.

14. An apparatus as in claim 13 wherein said heat dissipation fin assembly is a plurality of round folded fms.

15. An apparatus as in claim 13 wherein said heat dissipation fin assembly is a plurality of lanced offset fins.

16. An apparatus as in claim 13 wherein said heat dissipation fin assembly is an extruded structure featuring a plurality of fins.

17. A liquid cooled electric motor apparatus, said apparatus comprising:
a rotor shaft with a hollow center having a tubular extrusion with featuring a plurality of extruded fins affixed to first and a second rotor shaft distal end, said first rotor shaft distal end having an axial aperture leading to the hollow center of said rotor shaft and said second rotor shaft distal end having a closed end;
a rotor assembly rigidly affixed to said rotor shaft;
a stator assembly being rotatably engaged with said rotor shaft;
a cooling tube, with a first and a second cooling tube distal end, supported in an internal and coaxially orientation in relation said rotor shaft such that said first cooling tube distal end is located outside of said rotor shaft proximate to said first rotor shaft distal end and said coolant tube extends through said axial aperture in said first rotor shaft distal end and terminates at said second cooling tube distal end located in the hollow center of said rotor shaft, so that cooling fluid may enter said cooling tube at said first cooling tube distal end and flow in a first direction until it exits said cooling tube at said second cooling tube distal end and then is directed to flow in a second, opposite direction through the space defined by the external surface of said cooling tube and the internal surface of said rotor shaft;

18. An apparatus as in claim 17 wherein said cooling tube is supported by a coolant tube support firmly adjoined to said coolant tube's first distal end supporting said coolant tube in a cantilever fashion.

19. An apparatus as in claim 17 wherein said cooling tube is stationary and does not rotate with said rotor shaft.

20. An apparatus as in claim 17 wherein said cooling tube rotates with said rotor shaft.
